(19) United States
(12) Patent Application Publication
(10) Pub. No.: US 2006/0015661 A1
(43) Pub. Date: Jan. 19, 2006

(54) Visual display for USB storage key

(75) Inventors: Timothy Alan Dietz, Austin, TX (US); Walid M. Kobrosly, Round Rock, TX (US); Nadeem Malik, Austin, TX (US)

Correspondence Address: International Business Machines;Intellectual Property Law, 11400 Burnet Road, Austin, TX, 78758, US

(73) Assignee: International Business Machines Corporation, Armonk, NY (US)

(21) Appl. No.: 10/891,766

(22) Filed: Jul. 15, 2004

(51) Int. Cl. G06F 13/00

(52) U.S. Cl. 710/62

(57) ABSTRACT

A system, method, and related computer program for visually displaying the contents of a USB storage device, wherein a USB storage device is inserted into a computer controlled instrument and a special storage area in the storage portion of the computer controlled instrument holds low resolution bitmaps of stored images. These low resolution bitmaps contain such data as directory listings, which can be displayed on an LCD without the inconvenience or difficulty of the current method of displaying such information. Low resolution images with stored files as bitmaps are automatically updated. The present invention functions via a small LCD screen and its controller, which is added to the USB storage key and allows for the display of the contents stored on the USB storage key. The present invention allows a user access to the listing of the contents stored on a USB storage key without having to plug in the USB storage key into a computer controlled instrument.

### TECHNICAL FIELD

The present invention relates to computer controlled consumer electronics devices or instruments, such as digital cameras, and specifically to the visual display for USB storage keys.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years to now come into great demand in the marketplace.

The rapid expansion in the capacity of computers to perform support functions, the greater and greater miniaturization of computers, as well as reduction in costs to perform memory and computer operations has opened the door for computer controlled instrumentation. A key aspect of this expansion has been lower and lower cost memory. In recent years, this has been manifested in flash memory cards and sticks. At the current technology stage, these memory cards and sticks are detachably inserted into the computer controlled electronic instruments to provide an extra memory capacity of from one half to four to five gigabytes.

Memory cards use a flash memory that is based upon EEPROM (electrically erasable programmable read only memory) grid chips. Flash memory EEPROM works much faster than conventional EEPROM. Instead of erasing one byte at a time, it erases an entire block or an entire chip at a time and then rewrites. Smartmedia and Compactflash provide the “electronic film” for digital cameras while the Sony memory stick is quite popular in digital cameras and for computer controlled video games. These high capacity memory cards and sticks have been performing hard drive storage functions for the above-described computer controlled electronic instruments. In this connection, the SSFDC (solid state floppy disc card) developed by Toshiba, Inc. may function as the above-described Smartmedia card. Similarly, the above CompactFlash is a small circuit board with at least one flash memory chip and a dedicated controller chip encased in a housing or shell.

With this rapid expansion of the use of detachable memory cards for an increasing variety of computer controlled electronic instruments, the cards themselves are becoming relatively ubiquitous. The memory cards may be in or on the desks and cabinets of their users. There is presently no way of efficiently determining from a USB storage device or memory card the contents stored thereon until the device is plugged into a computer controlled instrument. If the device is inserted into the computer controlled receiving instrument, there may be routines in the computer for the controlled instrument to bring up and display contents of the inserted USB storage device or memory card. However, this is generally awkward and requires several steps. If the USB storage devices or memory cards are stored in the detached state, there is no available way of determining the contents stored thereon. In accordance with an aspect of this invention, the USB storage device may include a very basic power supply so as to support the indicator whenever the device is detached from its computer controlled electronic instrument.

The present invention involves a USB storage key as a memory card. The Universal Serial Bus (USB), which was originally developed in 1995 by Intel, Compaq, DEC, IBM, Microsoft, NEC, and Northern Telecom, to define an external expansion bus that simplified adding peripherals to a PC with low cost to the user. The USB has a data transfer rate of 12 megabits per second (Mbps) for connecting peripherals to a microcomputer. USB can connect up to 127 peripherals, such as external CD-ROM drives, printers, modems, mice, and keyboards to the system through a single, general purpose port, which is accomplished by daisy chaining peripherals together. USB is designed to add such devices without having to shut down and restart the system. Currently, USB enjoys tremendous success in the marketplace, and most peripheral vendors are developing products to this specification. Virtually all new PCs have one or more USB ports included thereon.

To better understand USB, an understanding of the roles of each of its major elements is necessary, which is described in greater detail in the article “Understanding Universal Serial Bus Part 1: USB Basics”, Embedded Systems Programming, John Canosa, Miller Freeman, San Francisco, Calif., USA, June 1997. These major elements are the host PC hardware and software, the hub, and the peripheral. The role of the system software is to provide a uniform view of I/O systems for all applications software. The system software hides hardware implementation details causing the application software to be more portable. For the USB I/O subsystem, the system software manages the dynamic attach and detach of peripherals. This phase is called enumeration, and involves communicating with the peripheral to discover the identity of a device driver that should be loaded if it has not been loaded yet. A unique address is assigned to each peripheral during enumeration to be used for run-time data transfers. During run-time, the host PC initiates transactions to specific peripherals, and each peripheral accepts its transactions and responds accordingly. The host PC software incorporates the peripheral into the system power management scheme and can manage overall system power without user interaction.

The role of the hub is to provide managed power to attached peripherals, in addition to its obvious role of providing additional connectivity for USB peripherals. The hub recognizes dynamic attachment of a peripheral and provides at least 0.5 W of power per peripheral during initialization. Under control of the host PC software, the hub may provide more device power, up to a maximum of 2.5 W, for peripheral operation. A newly attached hub will be assigned its unique address, and hubs may be cascaded up to five levels deep. During run-time, a hub operates as a bi-directional repeater and will repeat USB signals as required on upstream (towards the host) and downstream (towards the device) cables. The hub also monitors these signals and handles transactions addressed to itself. All other transactions are repeated to attached devices. A hub of USB, version 1.1, supports both 12 Mbps (full-speed) and 1.5 Mbps (low-speed) peripherals. USB, version 2.0, offers its users an additional range of higher performance peripherals, such as video-conferencing cameras, and increases data throughput by a factor of 40, since it has a higher bandwidth. USB 2.0 has 480 Mbps bandwidth.

All USB peripherals must react to request transactions sent from the host PC. The peripheral responds to control request transactions sent from the host PC. The peripheral responds to control transactions that, for example, request detailed information about the device and its configuration. The peripheral sends and receives data to/from the host using a standard USB data format. This standardized data movement to/from the PC host and interpretation by the peripheral gives USB its enormous flexibility with little PC host software changes. USB peripherals can operate at 12 Mbps or 1.5 Mbps. Presently, computer systems and cameras sold in the marketplace include integrated USB ports as a general feature, and USB storage keys are becoming a ubiquitous means of storing computer data, images and other electronic content.

### SUMMARY OF THE PRESENT INVENTION

The present invention provides a solution to the problems related to the difficulty and inconvenience of determining the stored contents on a USB storage key or memory card. Accordingly, the present invention provides a visual display for a USB storage device, with a means for inserting the USB storage device into a computer controlled instrument for storing data thereon. The visual display for a USB storage key also has a means for designating a special storage area in the storage portion of the computer controlled instrument for holding low resolution bitmaps of stored images. These low resolution bitmaps of the present invention's visual display contain directory listings which can be displayed on an LCD (Liquid Crystal Display). The visual display further includes means for automatically updating said low resolution images with stored files as bitmaps. The files are stored while the computer controlled instrument is powered off.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic illustration of a USB key drive in accordance with the present invention capable of being inserted into a computer controlled electronic instrument, i.e. a digital camera, for storing images or data thereon for visual display;

FIG. 2 is a diagrammatic illustration of a USB storage key in accordance with the present invention simplified to illustrate the visual display;

FIG. 3 is a block diagram of a simplified control circuitry on controller integrated circuitry on an IC chip on a USB storage key in accordance with this invention;

FIG. 4 is an illustrative flowchart in accordance with this invention showing how the visual display of data from a USB storage key is displayed; and

FIG. 5 is a flowchart of an illustrative run of the process set up in FIG. 4.

### DETAILED DESCRIPTION OF THE PREFERRED EMBODIMENT

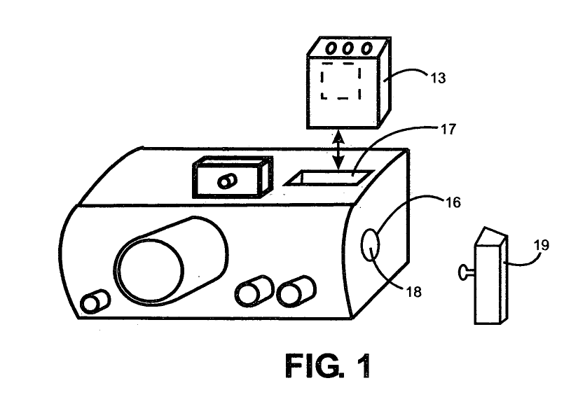

Referring to FIG. 1, a typical use of the USB storage key's visual display of the present invention in connection with a computer controlled instrument, e.g. a digital camera, is shown. The camera 16 has a slot 17 into which a typical memory card 13 may be removably inserted to operatively engage the computer system in the camera to function as a typical extended memory card, and a USB storage key for similarly storing data which is also removeable, and will be hereinafter described in greater detail. The digital camera 16 has a USB connection slot 18 adapted to receive a USB storage key 19. Of course, the operations to be described will be applicable to a USB storage key and computer controlled instrument co-action.

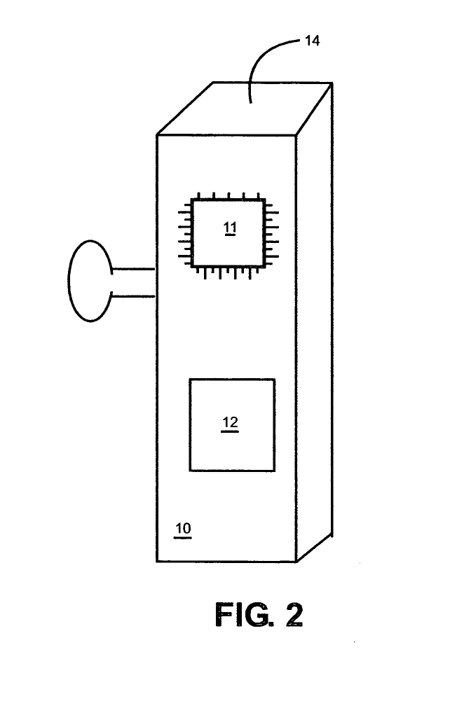

A USB storage key, illustrated in FIG. 2, comprises a housing 10 in which there is mounted and wired the memory array 11 and supporting logic that herein is in the form of an integrated circuit logic chip that functions as a controller 12. An alternative, which is coming into some limited usage as the demand for memory cards and the like increases, is to have the CPUs in the computers in the instruments receiving the cards or devices have already built in interfaces for performing the functions of controller 12. In the simplified illustration of FIG. 2, a visual display on the USB storage device displays low resolution bitmaps of stored images, such as directory listings, on an LCD display positioned in the upper wall 14, which is powered through the USB socket. If the contents stored on the USB key are JPEG or other image file types, the screen can also display a thumbnail of the image. Since decoding a JPEG image is computer intensive and may not be possible for the simple LCD controller described in this invention, a special storage area within the USB storage key is used to hold a low resolution bitmap of the stored images.

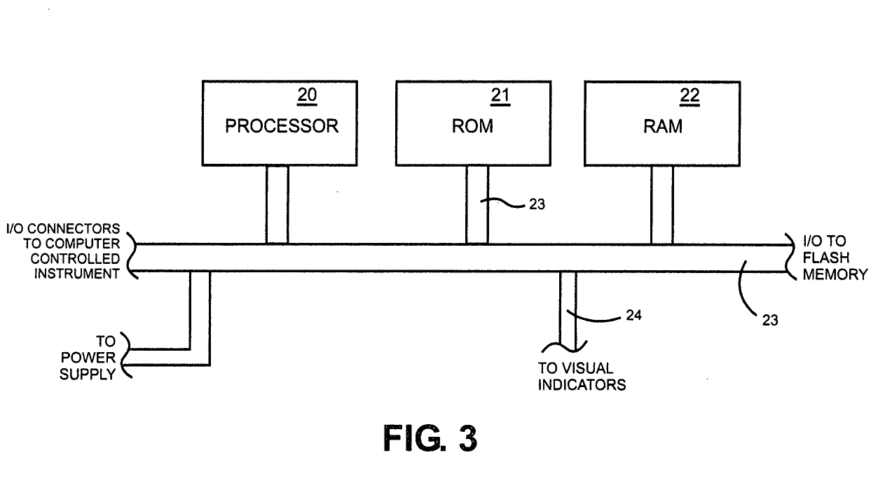

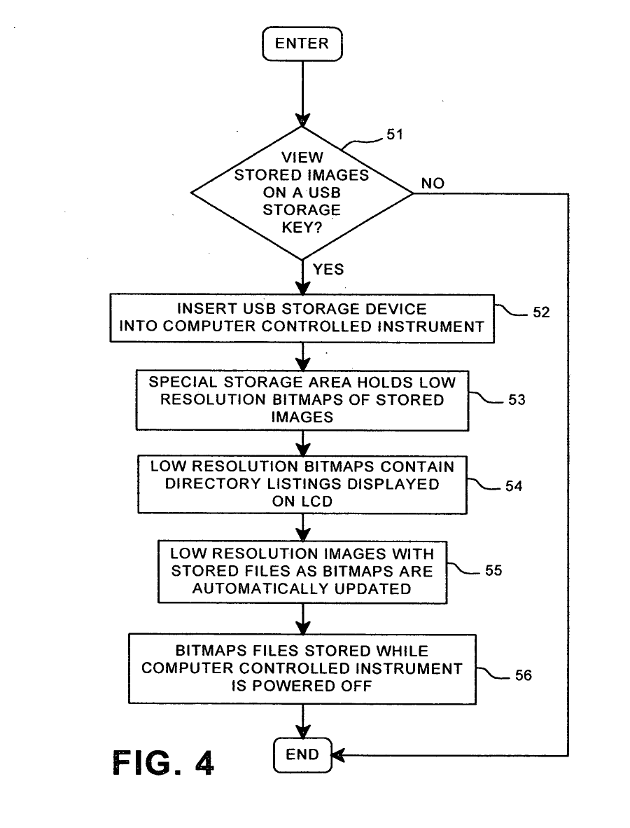

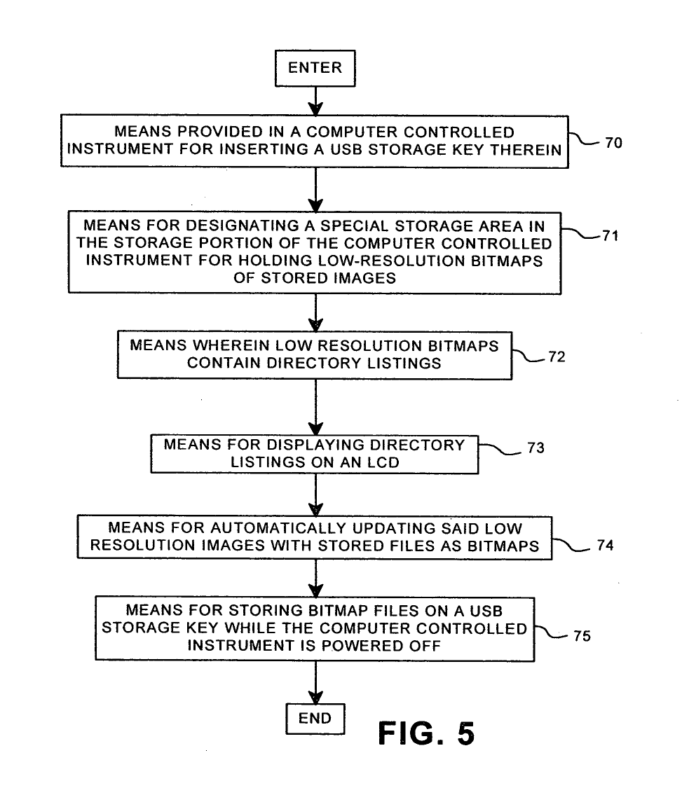

FIG. 3 is a block diagram of simplified control circuitry on controller integrated circuitry on an IC chip 12 of a memory card 13, and the storage of data onto a USB storage key and the transfer of said stored data to a computer controlled instrument in accordance with this invention. In order to better understand the present invention, an understanding of the memory card is necessary. The controller chips provide specific purpose logic to control the access, reading and writing into the flash memory array chips 11. These logic or control chips contain data processors 20, operating systems stored in RAM 22 and a permanent programmable memory, and a programmable ROM 21 that may be EEPROM, e.g. flash EEPROM. All of the routines and programs may also be conventionally stored in this flash EEPROM 21. These include memory card operating systems and built-in applications that may also be conventionally stored in the RAM. The visual display of a USB storage key contains a system bus 23 connected via I/O output at one end to the conventional connectors of the camera 16 to the computer controlled instrument. In accordance with the present invention, this relatively standard structure is modified to have an appropriate connection via bus 24 to a visual display. The indicators are controlled through the controller processor 20 in accordance with the routines illustrated in FIG. 4 and FIG. 5, to be subsequently described.

There is also shown a bus branch to a power supply. Where the USB storage key is functioning already operatively inserted into the computer controlled instrument, the power supply of the instrument itself may be used for this function. On the other hand, it is important to the practice of the present invention that when the USB storage key is not engaged with the computer controlled instrument, the indicators still function as described. In such a case, a simple capacitive circuit arrangement may be used that will store sufficient electrical power when the USB storage key is operatively engaged wit the computer controlled instrument so that the visual indicators may be powered even when the USB storage key is not in active use, i.e. on the desktop or drawer. Of course, in a newly manufactured device, this capacitive power may be initially stored by an initial charge. By use of the present invention, the user is able to view the contents of stored data, such as directory listings, on a USB storage key via LCD without plugging the USB storage key into a computer controlled instrument. Whenever a computer controlled instrument stores a file on the USB storage key, the special storage area with bitmaps is also updated automatically. It should be understood with respect to this invention that computer power may or may not exist with a digital camera or other lower-end device for the automatic updating of bitmaps on files on the USB storage key special storage area.

The running of the process set up in FIG. 3 will now be described with respect to the flowchart of FIG. 4. The flowchart represents some steps in a routine that will illustrate the operation of the invention. A determination is made as to whether the user wants to view stored images on a USB storage key, step 51. If No, the process ends. If Yes, the user inserts the USB storage device into a computer controlled instrument, step 52. A special storage area is designated in the storage portion of the computer controlled instrument for holding low resolution bitmaps of stored images, step 53. Low resolution bitmaps containing directory listings are displayed on an LCD, step 54. The low resolution images with stored files as bitmaps are automatically updated, step 55. Bitmap files are stored while the computer controlled instrument is powered off, step 56.

Referring now to FIG. 5, an illustrative flowchart in accordance with this invention showing how the visual display of a USB storage key that stores and displays the contents of the USB key on an LCD when a computer controlled instrument is powered off. Means provided in a computer controlled instrument for inserting a USB storage key therein, step 70. Means for designating a special storage area in the storage portion of the computer controlled instrument for holding low resolution bitmaps of stored images, step 71. Means wherein low resolution bitmaps contain directory listings, step 72. Means for displaying directory listings on an LCD, step 73. Means for automatically updating said low resolution images with stored files as bitmaps, step 74. Means for storing bitmap files on a USB storage key while the computer controlled instrument is powered off, step 75.

Although certain preferred embodiments have been shown and described, it will be understood that many changes and modifications may be made therein without departing from the scope and intent of the appended claims.

What is claimed is:

1. A USB storage device body insertable into a computer controlled instrument, a visual display in said body, comprising:
means for designating a special storage area in the storage portion of the computer controlled instrument for storing low resolution bitmaps of stored images.

2. The USB storage device body of claim 1 wherein said low resolution bitmaps contain directory listings.

3. The USB storage device body of claim 2 wherein said directory listings are displayed on an LCD (Liquid Crystal Display).

4. The USB storage device body of claim 3 further including means for automatically updating said low resolution images with stored files as bitmaps.

5. The USB storage device body of claim 4 wherein the bitmap files are stored while the computer controlled instrument is powered off.

6. A method for visually displaying on a USB storage device, stored data, including the steps of:
inserting the USB storage device into a computer controlled instrument; and
designating a special storage area in the storage portion of the computer controlled instrument for storing low resolution bitmaps of stored images.

7. The method of claim 6 wherein said low resolution bitmaps contain directory listings.

8. The method of claim 7 wherein said directory listings are displayed on an LCD (Liquid Crystal Display).

9. The method of claim 8 further including the step of updating said low resolution images with stored files as bitmaps automatically.

10. The method of claim 9 wherein the bitmap files are stored while the computer controlled instrument is powered off.

11. A computer program having code recorded on a computer readable medium for a USB storage device body insertable into a computer controlled instrument, a visual display in said body, comprising:
means for designating a special storage area in the storage portion of the computer controlled instrument for storing low resolution bitmaps of stored images.

12. The computer program of claim 11 wherein said low resolution bitmaps contain directory listings.

13. The computer program of claim 12 wherein said directory listings are displayed on an LCD (Liquid Crystal Display).

14. The computer program of claim 13 further including means for automatically updating said low resolution images with stored files as bitmaps.

15. The computer program of claim 14 wherein the bitmap files are stored while the computer controlled instrument is powered off.
